(19) United States
(12) Patent Application Publication
(10) Pub. No.: US 2006/0243525 A1
(43) Pub. Date: Nov. 2, 2006

(54) Ladder cushion

(76) Inventor: Brett Bengston, Brooklyn Park, MN (US)

Correspondence Address: Herman H. Bains, 6101 Tracy Ave., Minneapolis, MN, 55436, US

(21) Appl. No.: 11/113,289

(22) Filed: Apr. 25, 2005

(51) Int. Cl. E06C 7/42

(52) U.S. Cl. 182/107

(57) ABSTRACT

Ladder attachment means include a pair of ladder pads which are removably attached to a ladder for protection to gutters or building walls engaged by a ladder. The ladder pads are formed of a resilient, yieldable material and are of elongate, rectangular configuration. Each pad has an elongate T-shaped slot therein which defines a pair of rail-engaging arms for engaging the sides of a ladder rail when the pad is applied to a ladder. The pads are readily removable and serve to protect gutters and other building features from damage by ladders.

### FIELD OF THE INVENTION

This invention relates to ladder protection pads readily applicable to ladder rails for preventing damage to gutters against which a ladder is leaned.

### BACKGROUND OF THE INVENTION

Ladders are a principal tool used by building contractors, painting contractors, roofing contractors and similar professional workers for accessing high locations on business and residential buildings. Typically, the ladder is leaned in a generally upright position against a building and often times against gutters. Gutters are sometimes damaged and require repainting by the workmen. In coping with this problem, some users tie rags or other covering material around the upper end portions of the ladder in order to prevent damage to gutters or other external surfaces. These covering rags or materials often times become detached from the ladder rails making this kind of ad hoc solution undesirable. This invention is directed to providing a effective solution to this problem.

### SUMMARY OF THE INVENTION

It is an object of this invention to provide ladder attachment means for application to ladder rails to prevent damage to gutters and other external features of a building when ladders are positioned against gutters or other external building features.

The ladder attachment means comprises a pair of elongate, substantially identical pads formed of a yieldable, resilient material. Each pad is of generally rectangular cross-section shape and has a T-slot therein to permit ready attachment and removal from a ladder rail. The ladder attachment pads engage the surface against which the ladder is leaned and therefore protects these surfaces from damage by the ladder.

These ladder attachments not only have special utility for professional contractors but also has utility for home owners and handy men.

### BRIEF DESCRIPTION OF THE FIGURES OF THE DRAWINGS

FIG. 1 is a perspective view of a conventional extension ladder leaning against the gutter of a residential building and incorporating the novel ladder attachment means;

FIG. 2 is a cross-sectional view taken approximately along line 2-2 of FIG. 1 and looking in the direction of the arrows;

FIG. 3 is a fragmentary perspective view of a ladder attachment pad;

FIG. 4 is a top plan view of a ladder attachment pad; and

FIG. 5 is a side elevational of a ladder having the attachment pads secured thereto and leaning against the surface of a vertical wall of a building.

### DESCRIPTION OF THE PREFERRED EMBODIMENT

Referring now to the drawings it will be seen that the preferred embodiment of the novel ladder attachment, designated generally by the reference numeral 10, is thereshown. It will be seen that the ladder attachment 10 comprises a pair of substantially identical ladder pads 10a. The ladder pads 10a are secured to the rails 16 of a ladder 11. The ladder 11 is a conventional extension ladder and the ladder pads 10a are located adjacent the upper end of the ladder which engages a gutter 15 of the building 12. The building 12 is a residential building and includes vertical walls 13 and a conventional roof 14.

Each ladder pad 10a is of elongate generally rectangular configuration. The pads are formed of a yieldable, somewhat resilient material preferably ethylene vinyl acetate (TBE-20). In the embodiment shown, the properties of the ethylene vinyl acetate (TBE-20) is as follows: density (PCF) 2, tensile strength (PSI) 56, elongation 367%, tear strength (PLI) 10, compressive strength at 25% compression (PSI) 5, compressive strength at 50% compression (PSI) 13, compression set % original thickness 4.4% thermal stability (158° F.24 hrs.) 0.6%, and thermal conductivity (btu/hr/t^{2 0} F) 0.24. It will be appreciated that other similar materials may be used but the ethylene vinyl acetate (TBE-20) is the preferred embodiment.

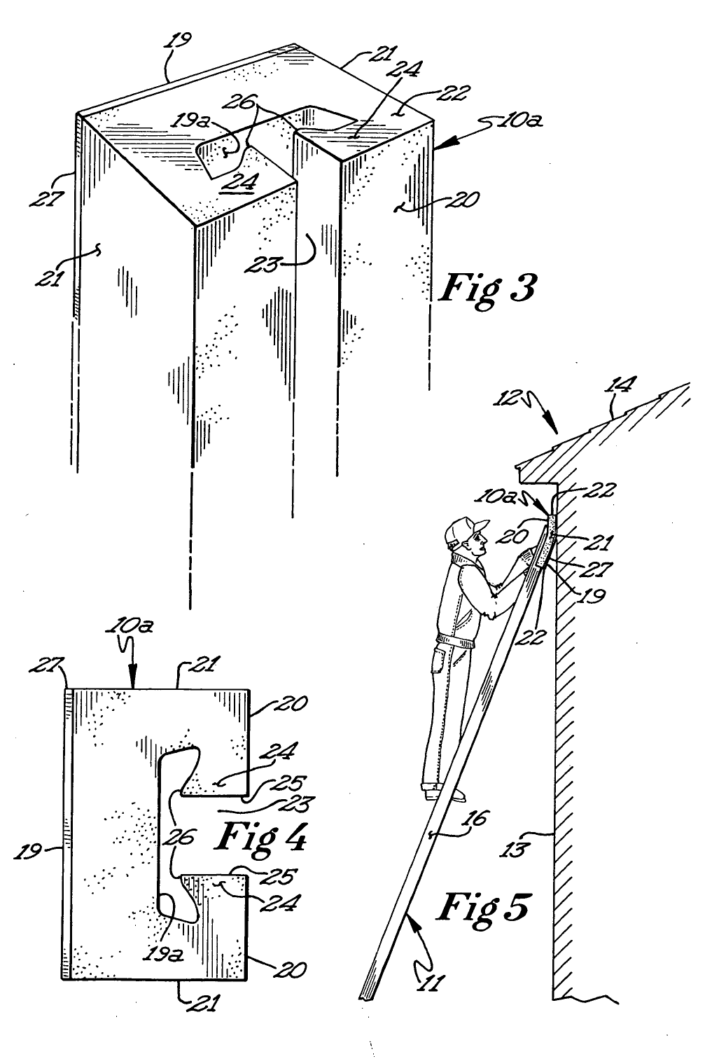

Referring again to the drawings, as best seen in FIG. 3 and 4, each ladder pad has opposed surfaces including a front surface 19, a rear surface 20, opposed side surfaces 21 and opposed end surfaces 22. Each pad has a generally T-shaped slot 23 therein extending through the rear surface 20 and which defines a pair of opposed arms 24 having opposed flat rail engaging surfaces 25. Each rail-engaging arm 24 has an inwardly projecting lip 26. It will also be noted that the front surface 19 has a non-skid element 27 secured thereto.

When the ladder pads 10a are applied to a ladder rail 16, the rail enters the T-shaped slot 23 until it engages the inner surface 19a, as best seen in FIG. 2. The rail-engaging surfaces 25 engage opposite sides of the ladder rail to firmly attach the pad to the rail.

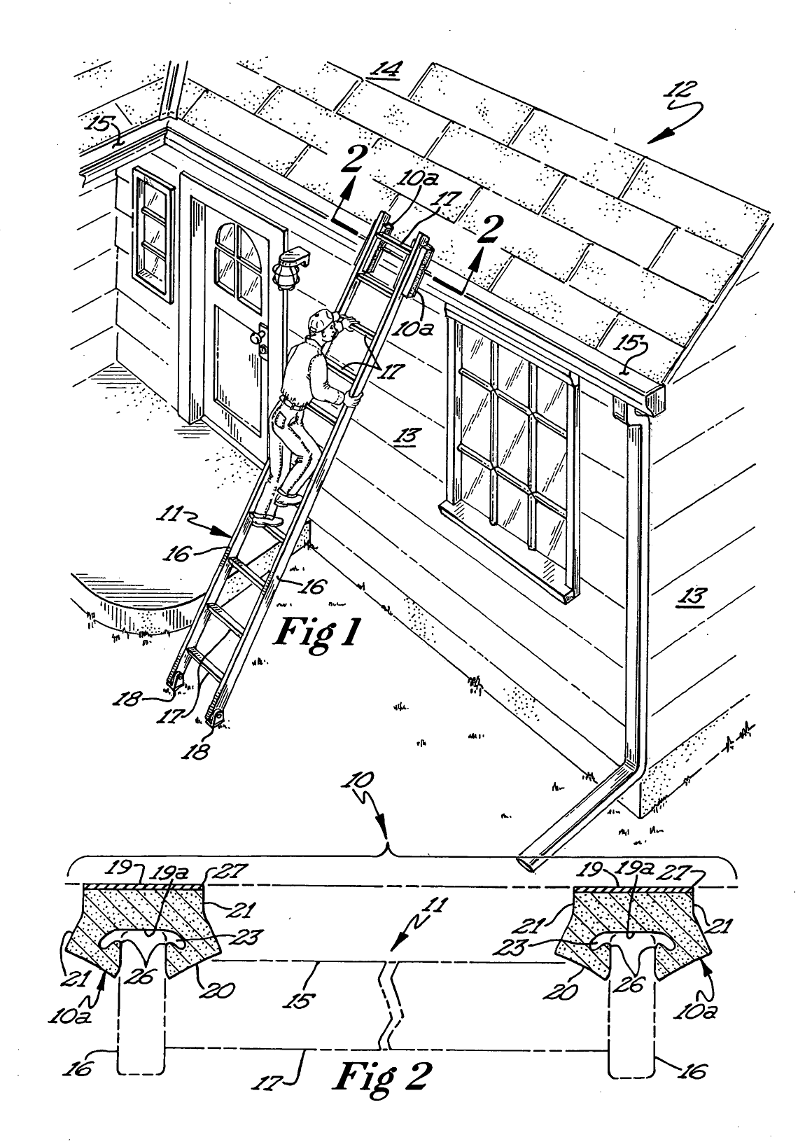

The pads will be located on the ladder rails to provide protection to the surface engaged by the ladder rails. For example, in FIG. 1, the ladder pads 10a are positioned at a location below the upper ends of the ladder rail to allow the ladder pads 10a to engage gutter 15. The pads are yieldable and protect the gutter from damage by the ladder rails. If the ladder rails directly engage the gutter, the rails can damage the surface coating of the gutter. The non-skid element 27 will engage the gutter and minimize any likelihood of the ladder sliding along the gutter.

Referring now to FIG. 5, it will be noted that the ladder is leaned against a vertical wall 13 of a building such that the upper ends of the ladder would normally press against the wall surface. However, it will be noted that the ladder pads are positioned so that the upper ends of the ladder are covered by the ladder pads which engage the wall surface. Therefore, the wall surfaces are protected against damage by the ends of the ladder. The ladder pads 10a can be slid along the rails until a rung 17 is engaged by an end of a pad 10a. In that event, the pad must be removed and repositioned.

In this regard, the pads 10a may be readily removed with a minimum of effort. Similarly the pads 10a may be readily applied to the rails of ladders.

From the foregoing, it will be seen that I have provided a ladder attachment means which effectively protects the gutters and walls of a building from damage by ladder during painting, roofing work and similar work functions.

What is claimed is:

1. Ladder attachment means for attachment to the rails of a ladder for protecting gutters and building walls against damage by the ladder rails, comprising,
a pair of substantially identical, elongate ladder pads formed of a yieldable, resilient material and each comprising opposed wall surfaces including front and rear surfaces, said rear surface having a T-shaped slot therein defining a pair of spaced apart opposed rail engaging arms for engaging opposed sides of a ladder rail inserted into the T-shaped slot for attaching a pad to a ladder rail such that when the ladder is leaned against a building gutter or building wall, the ladder pads will engage and protect the gutter or wall from damage by the ladder.

2. The ladder attachment means as defined in claim 1 wherein said rail-engaging arms have flat opposed surfaces for engaging the sides of a ladder rail.

3. The ladder attachment means as defined in claim 1 wherein each pad is of generally rectangular configuration.

4. The ladder attachment means as defined in claim 1 and an anti-skid element secured to the front surface of each ladder pad for preventing accidental movement of a ladder.

5. The ladder attachment means as defined in claim 1 wherein the inner end portion of each rail-engaging arm has an inwardly extending lip.

6. The ladder attachment means as defined in claim 1 wherein the T-shaped slot in each ladder pad defines a transverse inner surface disposed substantially parallel to the front surface and being engage by a ladder rail when a ladder pad is applied to a ladder rail.
